(19) United States
(12) Patent Application Publication
(10) Pub. No.: US 2007/0089555 A1
(43) Pub. Date: Apr. 26, 2007

(54) Composite gear

(76) Inventors: Koji Tomoda, Aichi (JP); Yoshihiro Shimazaki, Kanagawa (JP); Kyosuke Uemura, Tokyo (JP)

Correspondence Address: E I DU PONT DE NEMOURS AND COMPANY;LEGAL PATENT RECORDS CENTER, BARLEY MILL PLAZA 25/1128, 4417 LANCASTER PIKE, WILMINGTON, DE, 19805, US

(21) Appl. No.: 11/581,294

(22) Filed: Oct. 16, 2006

Related U.S. Application Data
(60) Provisional application No. 60/729,274, filed on Oct. 21, 2005.

(51) Int. Cl. F16H 55/14

(52) U.S. Cl. 74/443

(57) ABSTRACT

There is disclosed herein novel gear wheels comprising a core and teeth, where the core comprises a first material and the teeth comprisse this material together with a second material molded thereon as a skin. A variety of materials suitable for use with the invention are disclosed, together with methods for manufacture of these wheels and methods for transmitting torque between gear wheels.

### CROSS REFERENCE TO RELATED APPLICATIONS

This application claims the benefit of priority to U.S. Provisional Application No. 60/1729,274, filed Oct. 21, 2005.

### FIELD OF THE INVENTION

This invention relates to gears. More particularly, this invention relates to composite gears made from thermoplastic materials such as thermoplastic polymers.

### BACKGROUND

Gears made from a rigid material such as metal or metal alloys are well known and are used in many applications. Such gears may withstand high torque load forces, but have a significant shortcoming in that they generate a great deal of noise when they mesh with other metal gears.

Gears made from a thermoplastic material are also known and have been used to reduce the noise generated by metal gears. However, thermoplastic gears have significant disadvantages, in that they cannot withstand high torque load forces without damaging their gear teeth, and are more susceptible to wear than metal gears.

To solve the respective problems of metal and thermoplastic gears, several attempts have been made to manufacture composite gears having some metal components and some thermoplastic components. U.S. Pat. No. 3,719,103 to Streander and incorporated herein by reference in its entirety discloses one such attempt in which a thermoplastic panel is sandwiched between two rigid steel plates, with the assembly being thereafter bolted together. One purpose of the gear in U.S. Pat. No. 3,719,103 is to increase the torque rating of the gear under normal load conditions as compared to gears having teeth which are made from a thermoplastic material alone. The increased torque rating is achieved by having the steel plates control the bending of the plastic material since the plastic is sandwiched between the two steel plates. The torque rating is increased so that higher loads may be borne under normal conditions.

Another object of the design in U.S. Pat. No. 3,719,103 is to reduce gear noise. Although some noise reduction is achieved in the patented design, significant noise will still be generated by the gear since the steel plates limit the bending of the plastic teeth.

U.S. Pat. No. 5,852,951 to Santi and also incorporated herein by reference in its entirety also addresses the same problems by laminating a metal stamped plate between thermoplastic plates. However the '951 design suffers form the disadvantage that the manufacturing process is tedious and complex, involving as it does multiple types of materials and process steps.

Another approach has been to provide a composite gear which is supplied with plastic teeth that are fixed to a metal flange, as described in U.S. Pat. No. 4,143,973 to Hauser and also incorporated herein by reference in its entirety. Similarly U.S. Pat. No. 5,722,295 to Sakai et al., and incorporated herein in its entirety by reference, describes a gear with plastic injection molded teeth.

The disadvantage of structures that use an molding process to insert a second material onto a gear wheel fabricated integrally of a first material is that the gear is subjected to tangential forces and that bonding between the two materials is generally inadequate and limits forces that the structure may be subjected to.

The object of the present invention is an improved composite gear structure that combines the simplicity of fabrication of thermoplastic polymer materials with the high performance that can be obtained with single piece constructions.

### SUMMARY OF THE INVENTION

The laminated gear construction of the instant invention has been designed to provide improved gears having the self lubricating and quiet running features normally associated with plastic gears and yet retaining the load capacity characteristics of gears constructed of harder metals.

In one embodiment, the gear wheel of the invention comprises a core, and teeth, in which said core comprises a first material. Said teeth comprise the first material of the core together with a second material molded thereon as a skin, the second material imparting a desired property to the gear wheel, for example lubricity or wear resistance. The skin may be bonded to the core by means of a primer layer intermediate the first and secodn materials. Alternatively bonding may be achieved by a double injection molding process in which the second material is injected onto an insert that comprises the core of the gear and the second material has a higher latent heat of fusion than the first material and is molded in a liquid state onto the first material while the first material is in the solid state.

In a further embodiment of the invention the gear wheel the first material and the second material are both polyamides. In still further embodiments the first and second materials can be polyesters or polyacetals. Examples of materials are Zytel®-Hytrel®, Crastin®-Crastin®, Delrin®-Delrin®, Delrin®-Zytel®/Minlon®, all available from the Du Pont Company (Wilmington, Del.).

The gear wheel of the invention can optionally comprises fibers and the core comprises perforations, the perforations being configured such as to cause a flow pattern in the first material during manufacture of the core, said flow pattern orienting fibers in a way to provide rigidity and/or flexural strength to the core in a radial direction.

In a still further embodiment of the invention, the skin covering on the core, comprising the second material, is shaped in such a way that when a tooth from a first gear wheel is meshed with teeth from a second gear wheel that is lying in the same plane as the first gear wheel, the core of the tooth of the first gear wheel is in contact with at least part of the skin of the second gear wheel. The invention is also directed towards a process for manufacturing the composite gear. In one embodiment the second material is injection molded over the core. One embodiment of the method for manufacturing a gear wheel comprises the steps of;
I. molding a core from a first material, said core having teeth,
II. allowing the first material to solidify,
III. molding a skin made of a second material over the teeth.

Between II and III, a step, if required, of applying a primer can be optionally inserted.

### BRIEF DESCRIPTION OF THE DRAWINGS

FIG. 1 shows a schematic diagram of several views of one embodiment of the gear wheel of the invention.

FIG. 2 shows a schematic diagram of a further embodiment a tooth on a gear wheel of the invention.

FIG. 3 shows a schematic diagram of a still further embodiment of the invention in which the teeth on adjacent gear wheels of the invention mesh with each other.

FIG. 4 shows a schematic diagram of views of a further embodiment of the invention in which the core of the gear wheel comprises fibers

FIG. 5 shows a schematic diagram of a configuration of a process of the invention.

### DETAILED DESCRIPTION OF THE INVENTION

This invention is directed towards an improved gear wheel. In particular to an improved gear wheel that comprises a first material and a second material that are assembled in a way that the properties of the gear wheel combine the best of the properties of the two materials.

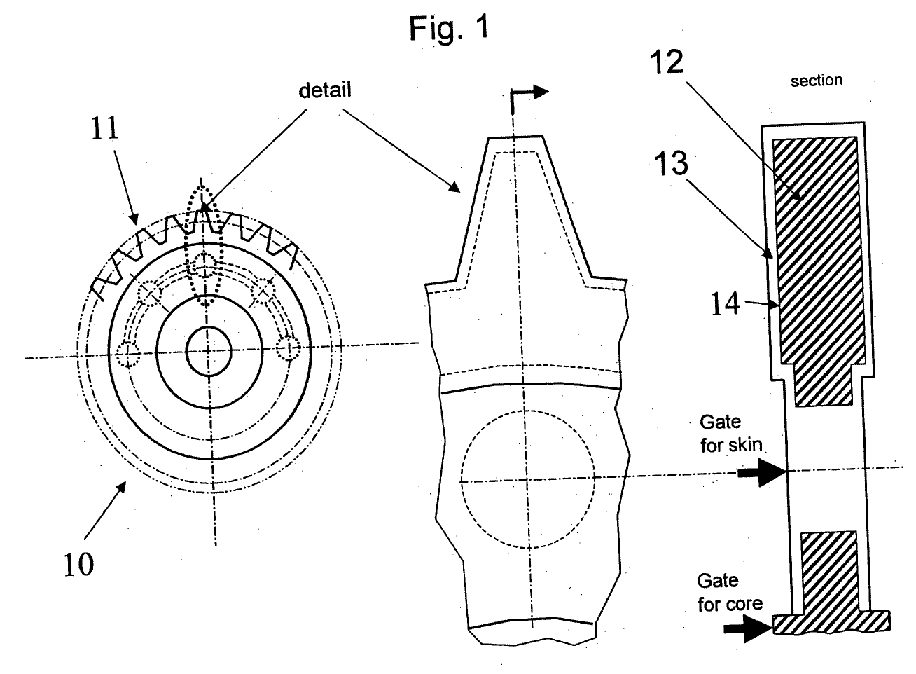

Referring now to FIG. 1, one embodiment of the gear wheel (10) is shown in three views. The wheel comprises teeth (11), an example of which is shown in the figure, however the scope of the claims is not to be construed as limited by the shape of the gear wheel shown in FIG. 1. In the section view shown in FIG. 1, the gear comprises a core (12) and a skin (13). In the example of FIG. 1 the skin covers 100% of the area of the teeth However in other embodiments of the invention, the skin may cover some fraction of the area of the teeth which is less than 100%. The skin and the core are bonded over all or part of their mutual contact area (14).

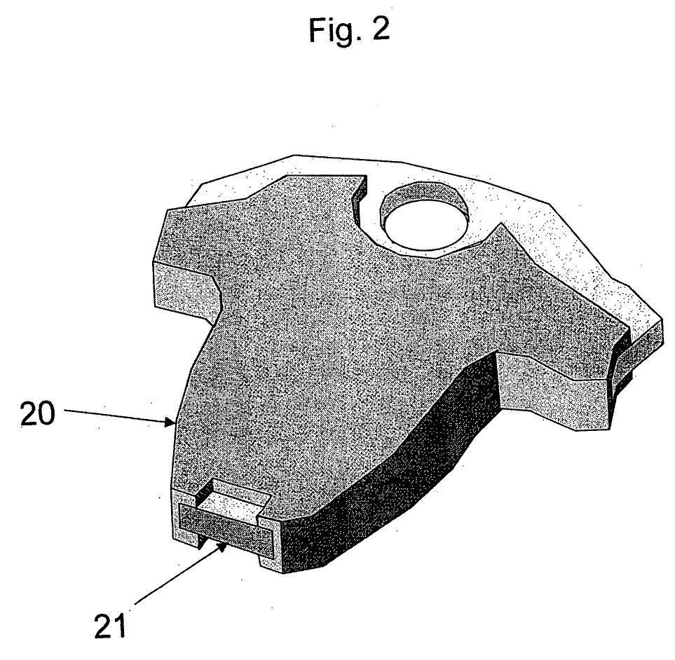

FIG. 2 shows an example of a second embodiment of a tooth of a gear of the invention. The skin (20) covers less than all of the area of the core (21). In FIG. 2 the tips of the teeth are left bare of skin. However the scope of the invention is not to be limited by the drawings and any configuration in which the teeth of the gear wheel are covered to any extent by the skin of the second material is within the scope of the invention.

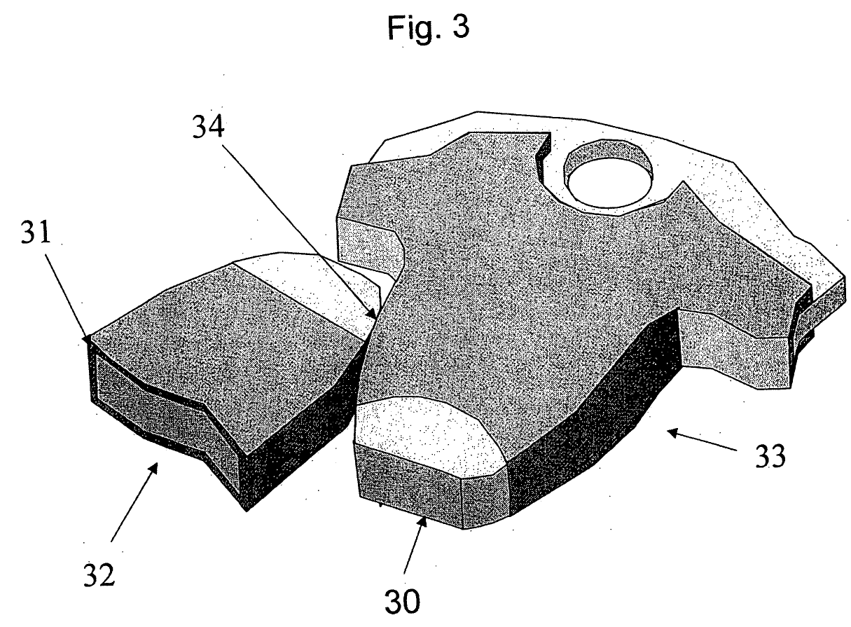

In FIG. 3 is shown a further embodiment in of the invention in which the core (30) of a first gear wheel (33) is molded from the first material. The skin covering on the teeth (31) of a second gear wheel (32) is configured in such a way that the core material of the first gear wheel contacts the skin covering of the second wheel when the gear wheels of the same invention mesh, for example at point 34, said skin covering comprising the second material.

Wear and abrasion performances of dissimilar materials in contact are known to be good in some cases and the proposed geometrical configuration of the gears could readily offer that benefit if the first and second materials are properly chosen.

The first and second materials can comprise any thermoplastic polymer that imparts a desired property to the gear wheel. In one embodiment of the invention, the first material will be a rigid polymer that imparts the desired flexural strength, rigidity and impact resistance to the core, and the second material will be a softer polymer that imparts a quieter performance in use. The polymers may be of the same species, for example both polyamides, or different species, for example a polyamide and a polyester. Examples of polymer combinations that can be used in both materials are polyamide+polyester block copolymer (Zytel®-Hytrel®), polyesters, (Ryntie®/Crastin®-Rynite®/Crastin®), polyacetal+polyacetal (Delrin®-Delrin®), polyacetal+polyamide of either unreinforced or glass/mineral reinforced (Delrin®-Zytel®/Minlon®), all available from the Du Pont Company (Wilmington, Del.). One skilled in the art will be able without undue experimentation to specify the correct molecular weight grades to comprise the two materials.

The polymers that can be used in the product of the invention are not limited to the commercial materials that are listed above. Any combination of polymers can be used that can be bonded. No particular limitation is imposed on the thermoplastic polymers that can be used in the manufacture of the product of the invention. Examples of thermoplastic polymers include aromatic polyesters such as polyethylene terephthalate, polybutylene terephthalate, polyethylene naphthalate, and polybutylene naphthalate; polyolefins such as polyethylene and polypropylene; polyacetals (homopolymer and copolymer); polystyrene, styrene-butadiene copolymers, acrylonitrile-butadiene-styrene copolymers, styrene-butadiene-acrylic acid (or its ester) copolymers, and acrylonitrile-styrene copolymers; polyvinyl chloride; polyamides; poly(phenylene oxide); poly(phenylene sulfide); polysulfones; polyether-sulfones; polyketones; polyether-ketones; polyimides; polyether-imides; polybenzimidazole; polybutadiene and butyl rubber; silicone resins; fluororesins; olefin-based thermoplastic elastomers, styrene-based thermoplastic elastomers, urethane-based thermoplastic elastomers, polyester-based thermoplastic elastomers, polyamide-based thermoplastic elastomers, and polyether-based thermoplastic elastomers; polyacrylate-based, core-shell type, multi-layered graft copolymers; and modified products thereof. These thermoplastic resins may be used in combination of two or more species.

Liquid crystalline polyesters (LCP's) can be used in the manufacture of the product of the invention. Examples of LCP's are those prepared from monomers including;

(i) naphthalene compounds such as 2,6-naphthalenedicarboxylic acid, 2,6-dihydroxynaphthalene, 1,4-dihydroxynaphthalene, and 6-hydroxy-2-naphthoic acid;

(ii) biphenyl compounds such as 4,4′-diphenyidicarboxylic acid and 4,4-dihydroxybiphenyl;

(iii) p-substituted benzene compounds such as p-hydroxybenzoic acid, terephthalic acid, hydroquinone, p-aminophenol, and p-phenylenediamine, and nucleus-substituted benzene compounds thereof (nucleus substituents being selected from chlorine, bromine, a C1-C4 alkyl, phenyl, and 1-phenylethyl); and

(iv) m-substituted benzene compounds such as isophthalic acid and resorcin, and nucleus-substituted benzene compounds thereof (nucleus substituents being selected from chlorine, bromine, a C1-C4 alkyl, phenyl, and 1-phenylethyl).

Among the aforementioned monomers, liquid crystalline polyesters prepared from at least one or more species selected from among naphthalene compounds, biphenyl compounds, and p-substituted benzene compounds are more preferred as the liquid crystalline polyester of used in the manufacture of the present invention.

Among the p-substituted benzene compounds, p-hydroxybenzoic acid, methylhydroquinone, and 1-phenylethylhydroquinone are particularly preferred.

In addition to the aforementioned monomers, the liquid crystalline polyester used in the present invention may contain, in a single molecular chain thereof, a polyalkylene tetrphthalate fragment which does not exhibit an anisotropic molten phase. In this case, the alkyl group has 2-4 carbon atoms.

Substances or additives which may be added to the thermoplastic used in the manufacture of the product of this invention, include, but are not limited to, heat-resistant stabilizers, UV absorbers, mold-release agents, antistatic agents, slip agents, antiblocking agents, lubricants, anticlouding agents, coloring agents, natural oils, synthetic oils, waxes, organic fillers, inorganic fillers, and mixtures thereof.

Examples of the aforementioned heat-resistant stabilizers, include, but are not limited to, phenol stabilizers, organic thioether stabilizers, organic phosphite stabilizers, hindered amine stabilizers, epoxy stabilizers and mixtures thereof. The heat-resistant stabilizer may be added in the form of a solid or liquid.

Examples of UV absorbers include, but are not limited to, salicylic acid UV absorbers, benzophenone UV absorbers, benzotriazole UV absorbers, cyanoacrylate UV absorbers, and mixtures thereof.

Examples of the mold-release agents include, but are not limited to natural and synthetic paraffins, polyethylene waxes, fluorocarbons, and other hydrocarbon mold-release agents; stearic acid, hydroxystearic acid, and other higher fatty acids, hydroxyfatty acids, and other fatty acid mold-release agents; stearic acid amide, ethylenebisstearamide, and other fatty acid amides, alkylenebisfatty acid amides, and other fatty acid amide mold-release agents; stearyl alcohol, cetyl alcohol, and other aliphatic alcohols, polyhydric alcohols, polyglycols, polyglycerols and other alcoholic mold release agents; butyl stearate, pentaerythritol tetrastearate, and other lower alcohol esters of fatty acid, polyhydric alcohol esters of fatty acid, polyglycol esters of fatty acid, and other fatty acid ester mold release agents; silicone oil and other silicone mold release agents, and mixtures of any of the aforementioned.

The coloring agent may be either pigments or dyes. Inorganic coloring agents and organic coloring agents may be used separately or in combination the invention.

Bonding of the first and second materials may be accomplished by any means known to one skilled in the art. In one embodiment of the invention bonding can be accomplished by using as a second material a polymer that has a higher latent heat of fusion than the first material. In the process for manufacturing the gear wheel, the second material is molded onto a core that comprises the first material. Without wishing to be constrained by mechanism, it is possible that the residual enthalpy from the cooling and crystallization of the second material causes a remelting of a thin layer of the first material and subsequent fusion and hence bonding of the first and second materials under the pressure of molding. In a further embodiment of the invention, bonding is accomplished by use of a primer or adhesive layer between the first and second materials. For example, an isopropanol based bonding agent for polyamide resins with the product name of “Cling-Aid” by Yamasei Kogyo Co., Ltd., is an example of such a primer when the first and second materials to be used are grades of polyamide. “Cling-Aid” comprises a solution of gallic acid (CAS number 149-91-7) in isopropanol.

The tensile strength of the bond between the first material of the core and the second material of the skin should be greater than 20 Mpa as measured by the tensile measurement perpendicular to the plane of the bond. Preferably the tensile strength should be greater than 50 Mpa, and most preferably greater than 80 Mpa.

The invention further relates to a process for manufacturing a composite gear wheel that comprises thermoplastic polymers. In one embodiment of the invention, the process comprises the steps of
i. molding a core from a first material, said core having teeth,
ii. allowing the first material to solidify,
iii. molding a skin made of a second material over the teeth.
   Between II and III, a step of applying a primer to the core before the step of molding the skin can be optionally inserted. Primer can be applied by any means known to one skilled in the art. For example, manual application by means of a brush.

Molding of the core from the first material can be accomplished by any molding method known to those skilled in the art. For example, injection molding machines are well known, and produced my manufacturers such as Toshiba, Sumitomo, Nissei, Fanuc, Battenfeld, Engels. In the injection molding process molten polymer is injected under pressure into a mold of the required shape and dimensions. The mold is cooled and the final part ejected. For the process of the invention, the ejected part is used, after trimming if necessary, as a core for a second injection of the second material. The core needs to be firmly held in the mold so that the pressure to be exerted by the polymers of the second injection will not deform or dislocate the core then causes dimensional inaccuracy of the gear. The movement of the core in the mold is usually called “core shift” and it is particularly significant when the pressure imbalance becomes large. In order to minimize this imbalance, the flow path of the second material needs to be determined so that the pressure on the all sides of the core at any given timing of the filling could cancel each other. For example, when the melt front advancement in the front side of the core and the back is equal, the pressure by it on the core could be assumed in an equilibrium state. The second material forming the skin over the core is inevitably to be filled from one side, namely the cavity side. So, if there is no particular consideration is given, the core will deform toward the core side as the melt spreads faster on the cavity side than the core side. In one embodiment of the onvention, perforations are optionally provided on the core are meant to provide the flow path connecting the both sides of the core, then to balance the pressure on the core.

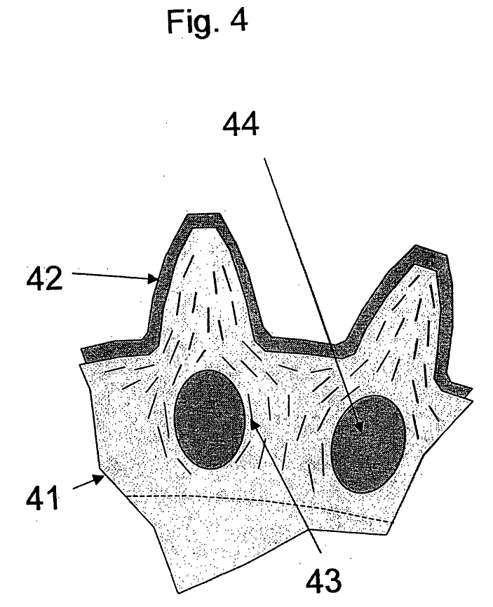

FIG. 4 shows an example of a core (41) with perforations (44) defining a cavity (42) into which the skin is to be molded. In an embodiment of the invention in which the first material comprises fibers (43), the location and size of the perforations ensures that the orientation of the fibers in the molded product favors for the a high flexural strength for the teeth of the gear. The perforations ensure that the flow pattern of the skin material around the core is even enough to avoid core shift.

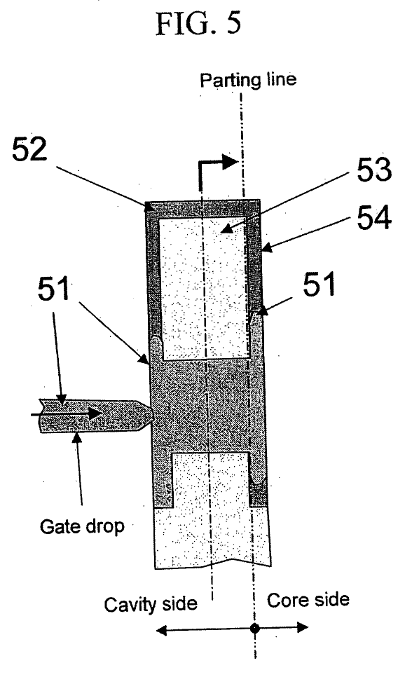

FIG. 5 shows an embodiment of the process of the invention in which a melt (51) is injected into a gap (52) formed by a core (53) and a mold wall (54).

The invention has been described in detail with particular reference to preferred embodiments thereof, but it will be understood by those skilled in the art that variations and modifications can be effected within the spirit and scope of the invention.

We claim:

1.) A gear wheel comprising a core, and teeth, in which said core comprises a first material, said teeth comprising the first material of the core together with a second material molded thereon as a skin.

2.) The gear wheel of claim 1 in which the skin is bonded to the core by means of a primer layer.

3.) The gear wheel of claim 1 in which the second material has a higher latent heat of fusion than the first material and is molded in a liquid state onto the first material while the first material is in the solid state.

4.) The gear wheel of claim 3 in which the first material and the second material are independently selected from the group consisting polyamides, polyesters, liquid crystalline polymers, polyolefins, polyacetals (homopolymer and copolymer), polystyrene, styrene-butadiene copolymers, acrylonitrile-butadiene-styrene copolymers, styrene-butadiene-acrylic acid (or its ester) copolymers, and acrylonitrile-styrene copolymers; polyvinyl chloride; polyamides; poly(phenylene oxide); poly(phenylene sulfide); polysulfones; polyether-sulfones; polyketones; polyether-ketones; polyimides; polyether-imides; polybenzimidazole; polybutadiene and butyl rubber; silicone resins; fluororesins; olefin-based thermoplastic elastomers, styrene-based thermoplastic elastomers, urethane-based thermoplastic elastomers, polyester-based thermoplastic elastomers, polyamide-based thermoplastic elastomers, and polyether-based thermoplastic elastomers; polyacrylate-based, core-shell type, multi-layered graft copolymers; and modified products and combinations thereof.

5.) The gear wheel of claim 1 in which the bond strength between the core and the skin is greater than 20 MPa.

6.) The gear wheel of claim 1 in which the first material comprises fibers

7.) The gear wheel of claim 1 in which the core comprises perforations.

8.) A method for manufacturing a gear wheel comprising the steps of;
I. molding a core from a first material, said core having teeth,
II. allowing the first material to solidify,
III. molding a skin made of a second material over the teeth.

9.) The method of claim 8 in which the second material has a higher latent heat of fusion than the first material.

10.) The method of claim 8 in which the first material comprises fibers and the core comprises perforations, the perforations being configured such as to cause a flow pattern in the first material during manufacture of the core, said flow pattern orienting fibers in a way to provide rigidity to the core in a radial direction.

11.) The method of claim 8 further comprising the step of adding a primer to the surface of the first material.

12.) A method for transmitting torque between two gear wheels comprising the steps of;
i) providing a first gear wheel that has a plane, and applying a torque such that the first gear wheel rotates about an axis that is perpendicular to the plane of the first gear wheel,
ii) providing a second gear wheel, so that the plane of the second gear wheel is coplanar with the plane of the first gear wheel and positioned such that teeth of the second gear wheel are able to mesh with teeth on the first gearwheel,
in which the teeth of the first gear wheel and of the second gear wheel both comprise a core, the core comprising a first material and a skin, the skin comprising a second material, and in which the skin is disposed over the surface of the core in each wheel in such a way that when a tooth from the first gear wheel comes into mesh with any teeth from the second gear wheel as both wheels rotate, the skin of the first gear wheel contacts the core of the second gear wheel.
